(19) United States
(12) Patent Application Publication
(10) Pub. No.: US 2014/0267314 A1
(43) Pub. Date: Sep. 18, 2014

(54) SYSTEMS AND METHODS FOR MICROBUBBLE GENERATION IN A LIQUID-FILLED DISPLAY

(71) Applicant: PIXTRONIX, INC., San Diego, CA (US)

(72) Inventors: Eugene E. Fike, III, Amesbury, MA (US); Jasper Lodewyk Steyn, Campbell, CA (US)

(73) Assignee: PIXTRONIX, INC., San Diego, CA (US)

(21) Appl. No.: 13/835,803

(22) Filed: Mar. 15, 2013

(51) Int. Cl. G02B 26/02; G06T 1/00

(52) U.S. Cl. CPC G02B 26/02; G06T 1/00
USPC 345/501; 359/230; 29/592.1

(57) ABSTRACT

This disclosure provides systems, methods and apparatus for a display including a fluid-filled cavity. The display can include a plurality of light modulators, and a viewable portion and a non-viewable portion. A bubble generator can be positioned within the non-viewable portion of the cavity and arranged to form a bubble within the non-viewable portion. The non-viewable portion of the display may include a region in which a bubble or bubbles are generated and allowed to move. The display may include a controller arranged to control the operation of the bubble generator. The display also may include a temperature sensor or pressure sensor arranged to measure the temperature or pressure of the display apparatus. The controller may control the operation of the bubble generator in response to a signal from either the temperature sensor, pressure sensor, or both.

### TECHNICAL FIELD

This disclosure relates to the field of displays, and more particularly, to liquid-filled displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, or other micromachining processes that etch away parts of substrates and/or deposited material layers, or that add layers to form electrical and electromechanical devices.

MEMS devices can function as switches, sensors, and display elements for devices such as cellular telephones, consumer electronic devices, and television monitors or displays. Certain displays incorporate mechanical light modulators that use movable electromechanical elements to perform light modulation. These displays can include hundreds, thousands, or in some cases, millions of moving elements. In some devices, every movement of an element is susceptible to misalignment which could disable or drastically reduce the performance and reliability of an electromechanical device.

Unlike liquid crystal displays, MEMS-based displays include hundreds, thousands, or in some cases, millions of moving elements. In some devices, every movement of an element provides an opportunity for static friction to disable one or more of the elements. This movement is facilitated by immersing all the parts in a working fluid (also referred to as fluid), usually one with a low coefficient of friction and minimal degradation effects over the long term.

Furthermore, because any working fluid used becomes part of the optical path of the device (and hence integral to its optical quality), the smallest changes in the state of the working fluid may have detrimental effects to the look and operation of the device. The walls containing the fluid in a MEMS direct-view apparatus form part of the display. In fact, it is common for them to be the largest portions of MEMS direct displays. This forces the builders to limit the amount of pressure under which the working fluid operates. Too much pressure and the display substrate may bulge in the center, affecting its optical qualities. At the other extreme, too low of an internal pressure will cause the fluid to boil if the working fluid is a liquid, it may form bubbles.

When the working fluid is a liquid such as an oil, gas bubbles may form from at least two primary sources. The first is air that may have been trapped during the manufacturing process or leaked in through the seals; the second is oil vapor, created by a low pressure situation. In effect, as the temperature drops, the oil contracts at a rate different to that of the substrates forming the enclosure. When this happens, and no prior bubbles are present, one or more bubbles may re-crystallize suddenly in one or more locations of the display. When these bubbles are formed within the viewable portion that a user looks at, they become an annoyance, usually leading to the replacement of the device.

Hence, there is a need to control the formation of display bubbles and their location within a display so that they do so within a portion of the display that is not viewable by a user.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus includes a cavity having a plurality of light modulators where the cavity is filled with a liquid. The cavity also includes a viewable portion and a non-viewable portion. The display apparatus also includes a bubble generator that is positioned within the non-viewable portion of the cavity and arranged to form a bubble within the non-viewable portion.

In some implementations, the display apparatus includes a controller arranged to control the operation of the bubble generator. The display apparatus also may include a temperature sensor arranged to measure the temperature of the display apparatus. In some implementations, the controller controls the operation of the bubble generator in response to a signal from the temperature sensor. The temperature sensor may be located within the cavity, outside the cavity, or in proximity to the cavity.

The display apparatus may include a pressure sensor in physical communication with the cavity and electrical communication with the controller. The controller may control the operation of the bubble generator in response to a signal from the pressure sensor. The bubble generator may include a heat source. The heat source may include a resistor or resistive element arranged to generate heat in response to a signal from the controller. In some implementations, the non-viewable portion of the display apparatus includes a region in which a bubble is allowed to form or move.

The display apparatus may be arranged to communicate with a processor where the processor is configured to process image data and communicate with a memory device. The display apparatus may receive at least one signal from a driver circuit configured to receive at least a portion of the image data from a controller. The processor may be configured to receive the image data from an image source module where the image source module includes at least one of a receiver, transceiver, and transmitter. The processor may be configured to receive input data from an input device. The processor may function as the controller for bubble generation.

Another innovative aspect of the subject matter described in this disclosure can be implemented in a method for controlling bubble formation within a display. The method includes providing a cavity having a plurality of light modulators where the cavity includes a viewable portion and a non-viewable portion, filling the cavity with a liquid, and generating a bubble using a bubble generator positioned within the non-viewable portion of the cavity. The method also may include measuring a temperature of the display. In some implementations, the method includes controlling the operation of the bubble generator in response to measuring the temperature of the display. Measuring may be performed by a temperature sensor located within the cavity. The process of controlling the operation of the bubble generator may be performed in response to a signal from a pressure sensor in physical communication with the cavity. The bubble generator may include a heat source. The heat source may include a resistor arranged to generate heat in response to a signal from the controller.

Another innovative aspect of the subject matter described in this disclosure can be implemented in a system for controlling bubble formation within a display. The system includes a cavity having a plurality of light modulators, and filled with a liquid. The cavity includes a viewable portion and a non-viewable portion. The system also includes a means for generating a bubble within the non-viewable portion of the cavity. In some implementations, the system includes means to control the operation of the bubble generator. The system also may include a means to measure the temperature of the display such that the means to control the operation of the bubble generator receives a signal from the means to measure the temperature.

Another innovative aspect of the subject matter described in this disclosure can be implemented in a method of manufacturing a display assembly. The method includes providing first and second substrates, providing a bubble generator on at least one of the first and second substrates, joining the first and second substrates via a sealing material arranged partially around the periphery of the first and second substrates to form a cavity such that the bubble generated is located within a non-viewable portion of the cavity, substantially filling the cavity with a fluid, and sealing the cavity. The method also may include forming at least one bubble trapping region on a surface of at least one of the first and second substrates.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

The foregoing discussion will be understood more readily from the following detailed description with reference to the following drawings

FIG. 1A is an isometric view of an example display apparatus.

FIG. 1B is a block diagram of the display apparatus of FIG. 1A.

FIG. 2 is a perspective view of an illustrative shutter-based light modulator suitable for incorporation into the MEMS-based display of FIG. 1A.

FIG. 3A is a schematic diagram of a control matrix suitable for controlling the light modulators incorporated into the MEMS-based display of FIG. 1A.

FIG. 3B is a perspective view of an array of shutter-based light modulators connected to the control matrix of FIG. 3A.

FIGS. 4A and 4B are plan views of a dual-actuated shutter assembly in the open and closed states respectively.

FIG. 5 is a cross-sectional view of a shutter-based display apparatus.

FIG. 6A is a diagram of a display assembly including a bubble generator.

FIG. 6B is a diagram of a display assembly including a resistive element.

FIGS. 7A-7C are views of display assemblies including bubble generators and bubble trapping regions on a substrate.

FIG. 8 is another view of a display assembly including a bubble generator and continuous bubble trapping region along the periphery of a substrate.

FIG. 9 is yet another view of a display assembly having a bubble trapping region.

FIGS. 10A and 10B are views of a display assembly including bubble trapping region locations formed by the geometric matching of substrates.

FIGS. 11A and 11B are top and side views respectively of a display assembly including spacers and wall bubble trapping region configurations.

FIG. 12 is a flow diagram of a process for controlling the formation of bubbles in a display assembly.

FIG. 13 is a flow diagram of a process for manufacturing a display assembly including a bubble generator.

FIGS. 14A and 14B are system block diagrams illustrating a display device that includes a plurality of light modulator display elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Certain displays use a liquid-filled cavity to house light modulators that are used to modulate light and, thereby, provide an image to a viewer. The cavity can be bounded by front and back glass substrates and sealed along its edges by epoxy. Because the thermal coefficient of the glass substrates is different than the liquid used to fill the cavity, as the temperature of the display decreases, the liquid contracts at a greater rate than the glass, resulting in the formation of bubbles within the cavity. Bubbles that form within a viewable portion of the display adversely obstruct the display image, resulting in degraded display quality. Also, bubbles can result in damage to light modulators, resulting in reduced display quality. Instead of preventing bubble formation within the cavity, one approach is to control the formation of bubbles in a way that prevents the adverse effects of bubble formation.

This may be achieved by, for example, having a display apparatus that includes a liquid-filled cavity housing light modulators where the cavity includes a viewable portion and a non-viewable portion. A bubble generator is positioned within the non-viewable portion of the cavity and arranged to form a bubble within the non-viewable portion. By encouraging the formation of a bubble in the non-viewable portion, the formation of bubbles within the viewable portion is inhibited.

Particular implementations of the subject matter described in this disclosure can be implemented to realize one or more of the following potential advantages. By including a bubble generator in a particular location, such as in a non-viewable portion of the fluid-filled cavity of a display, the formation of a bubble within the non-viewable portion is encouraged instead of in the viewable portion of the cavity. Hence, adverse bubble formation in a viewable potion of the cavity is inhibited. Additionally, various implementations may utilize a temperature sensor to measure the temperature of the fluid in the cavity and provide temperature data to a controller. The controller may use the temperature data to predictively determine when to initiate bubble formation using the bubble generator before a bubble can form in an undesirable portion of the cavity. The controller may advantageously interface with multiple temperature sensors within or outside of the display cavity to accurately and reliable assess display assembly temperature. Moreover, various implementations may include a pressure sensor that sends pressure data to the controller. The controller may control the bubble generator in response to one of temperature and pressure, or both. By implementing a bubble generator, particular implementations also avoid the need to introduce a bubble into the cavity during the manufacture or assembly a display. Furthermore, there is no longer a concern for maintaining a bubble in a display cavity because the bubble generator can induce a bubble in the cavity when needed.

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (for example, interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, for example, transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in sequences, which in some implementations may be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (for example, scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image 104 state is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image 104 state is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

FIG. 2 shows a perspective view of an example shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface 203 includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the aperture holes 211 are formed in a layer of light-blocking material deposited on the substrate 203. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and a separate set of “open” and “closed” electrodes for moving the shutter into either an open or a closed state.

There are a variety of methods by which an array of shutters and apertures can be controlled via a control matrix to produce images, in many cases moving images, with appropriate luminance levels. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

FIG. 3A shows a schematic diagram of an example control matrix 300. The control matrix 300 is suitable for controlling the light modulators incorporated into the MEMS-based display apparatus 100 of FIG. 1A. FIG. 3B shows a perspective view of an example array 320 of shutter-based light modulators connected to the control matrix 300 of FIG. 3A. The control matrix 300 may address an array of pixels 320 (the “array 320”). Each pixel 301 can include an elastic shutter assembly 302, such as the shutter assembly 200 of FIG. 2, controlled by an actuator 303. Each pixel also can include an aperture layer 322 that includes apertures 324.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source 309 (“V_{d} source”) to the pixels 301 in a corresponding column of pixels. In the control matrix 300, the V_{d} source 309 provides the majority of the energy to be used for actuation of the shutter assemblies 302. Thus, the data voltage source, V_{d} source 309, also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly actuates, opening the shutter in that shutter assembly 302. The voltage applied to the data interconnect 308 remains stored in the capacitor 312 of the pixel 301 even after the control matrix 300 ceases to apply V_{we} to a row. Therefore, the voltage V_{we} does not have to wait and hold on a row for times long enough for the shutter assembly 302 to actuate; such actuation can proceed after the write-enabling voltage has been removed from the row. The capacitors 312 also function as memory elements within the array 320, storing actuation instructions for the illumination of an image frame.

The pixels 301 as well as the control matrix 300 of the array 320 are formed on a substrate 304. The array 320 includes an aperture layer 322, disposed on the substrate 304, which includes a set of apertures 324 for respective pixels 301 in the array 320. The apertures 324 are aligned with the shutter assemblies 302 in each pixel. In some implementations, the substrate 304 is made of a transparent material, such as glass or plastic. In some other implementations, the substrate 304 is made of an opaque material, but in which holes are etched to form the apertures 324.

The shutter assembly 302 together with the actuator 303 can be made bi-stable. That is, the shutters can exist in at least two equilibrium positions (for example, open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 also can be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as the spring 207 in the shutter-based light modulator 200 depicted in FIG. 2, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on’ or “off” optical states in each pixel. Certain forms of coded area division gray scale are possible where multiple MEMS light modulators in the pixel are provided, and where apertures 324, which are associated with each of the light modulators, have unequal areas.

FIGS. 4A and 4B show views of an example dual actuator shutter assembly 400. The dual actuator shutter assembly 400, as depicted in FIG. 4A, is in an open state. FIG. 4B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with the shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 4B the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 4B shows a predefined overlap 416 between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

FIG. 5 shows a cross sectional view of an example display apparatus 500 incorporating shutter-based light modulators (shutter assemblies) 502. Each shutter assembly 502 incorporates a shutter 503 and an anchor 505. Not shown are the compliant beam actuators which, when connected between the anchors 505 and the shutters 503, help to suspend the shutters 503 a short distance above the surface. The shutter assemblies 502 are disposed on a transparent substrate 504, such a substrate made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition (CVD). In some other implementations, the rear-facing reflective layer 506 can be formed from a mirror, such as a dielectric mirror. A dielectric mirror can be fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap is preferably less than the lateral overlap between the edge of shutters 503 and the edge of apertures 508 in the closed state, such as the overlap 416 depicted in FIG. 4B.

The display apparatus 500 includes an optional diffuser 512 and/or an optional brightness enhancing film 514 which separate the substrate 504 from a planar light guide 516. The light guide 516 includes a transparent, i.e., glass or plastic material. The light guide 516 is illuminated by one or more light sources 518, forming a backlight. The light sources 518 can be, for example, and without limitation, incandescent lamps, fluorescent lamps, lasers or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display apparatus 500 to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light redirectors 517 can be molded into the plastic body of light guide 516 with shapes that can be alternately triangular, trapezoidal, or curved in cross section. The density of the prisms 517 generally increases with distance from the lamp 518.

In some implementations, the aperture layer 506 can be made of a light absorbing material, and in alternate implementations the surfaces of shutter 503 can be coated with either a light absorbing or a light reflecting material. In some other implementations, the aperture layer 506 can be deposited directly on the surface of the light guide 516. In some implementations, the aperture layer 506 need not be disposed on the same substrate as the shutters 503 and anchors 505 (such as in the MEMS-down configuration described below).

In some implementations, the light sources 518 can include lamps of different colors, for instance, the colors red, green and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps, or red, green, blue and yellow lamps. In some other implementations, the light source 518 may include cyan, magenta, yellow and white lamps, red, green, blue and white lamps. In some other implementations, additional lamps may be included in the light source 518. For example, if using five colors, the light source 518 may include red, green, blue, cyan and yellow lamps. In some other implementations, the light source 518 may include white, orange, blue, purple and green lamps or white, blue, yellow, red and cyan lamps. If using six colors, the light source 518 may include red, green, blue, cyan, magenta and yellow lamps or white, cyan, magenta, yellow, orange and green lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a distance away, which in some implementations may be predetermined, from the shutter assemblies 502 forming a gap 526. The gap 526 is maintained by mechanical supports or spacers 527 and/or by an adhesive seal 528 attaching the cover plate 522 to the substrate 504.

The adhesive seal 528 seals in a fluid 530. The fluid 530 is engineered with viscosities preferably below about 10 centipoise and with relative dielectric constant preferably above about 2.0, and dielectric breakdown strengths above about 10⁴ V/cm. The fluid 530 also can serve as a lubricant. In some implementations, the fluid 530 is a hydrophobic liquid with a high surface wetting capability. In alternate implementations, the fluid 530 has a refractive index that is either greater than or less than that of the substrate 504.

Displays that incorporate mechanical light modulators can include hundreds, thousands, or in some cases, millions of moving elements. In some devices, every movement of an element provides an opportunity for static friction to disable one or more of the elements. This movement is facilitated by immersing all the parts in a fluid (also referred to as fluid 530) and sealing the fluid (for example, with an adhesive) within a fluid space or gap in a MEMS display cell. The fluid 530 is usually one with a low coefficient of friction, low viscosity, and minimal degradation effects over the long term. When the MEMS-based display assembly includes a liquid for the fluid 530, the liquid at least partially surrounds some of the moving parts of the MEMS-based light modulator. In some implementations, in order to reduce the actuation voltages, the liquid has a viscosity below 70 centipoise. In some other implementations, the liquid has a viscosity below 10 centipoise. Liquids with viscosities below 70 centipoise can include materials with low molecular weights: below 4000 grams/mole, or in some cases below 400 grams/mole. Fluids 530 that also may be suitable for such implementations include, without limitation, de-ionized water, methanol, ethanol and other alcohols, paraffins, olefins, ethers, silicone oils, fluorinated silicone oils, or other natural or synthetic solvents or lubricants. Useful fluids can be polydimethylsiloxanes (PDMS), such as hexamethyldisiloxane and octamethyltrisiloxane, or alkyl methyl siloxanes such as hexylpentamethyldisiloxane. Useful fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. Other fluids considered for these display assemblies include butyl acetate and dimethylformamide. Still other useful fluids for these displays include hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

A sheet metal or molded plastic assembly bracket 532 holds the cover plate 522, the substrate 504, the backlight and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of the light guide 516 back into the light guide 516. Not depicted in FIG. 5 are electrical interconnects which provide control signals as well as power to the shutter assemblies 502 and the lamps 518.

The display apparatus 500 is referred to as the MEMS-up configuration, thus, the MEMS based light modulators are formed on a front surface of the substrate 504, i.e., the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in the display apparatus 500 and is oriented such that the MEMS-based light modulators are positioned on the rear surface of the top substrate, i.e., the surface that faces away from the viewer and toward the light guide 516. The MEMS-based light modulators are thereby positioned directly opposite to and across a gap from the reflective aperture layer 506. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures is preferably less than 10 microns, or a distance that is less than the overlap between shutters and apertures, such as overlap 416.

FIG. 6A is a diagram of a display assembly 600 including a bubble generator 602. The display assembly also includes a cavity 604 having a viewable portion 606 and a non-viewable portion 608. The bubble generator 602 is electronically connected with a controller 610. The display assembly further includes a temperature sensor 612 that is electronically connected with the controller 610. The temperature sensor 612 may be located in proximity with the display assembly 600. While FIG. 6A shows the temperature sensor being located outside of the cavity 604, the temperature sensor 612 may be located outside, within, adjacent to, or in physical contact with the cavity 604. The temperature sensor 612 may be positioned within the cavity 604 to more directly measure the temperature of a liquid within the cavity 604. The sensor also may be in contact with the display assembly 600. The liquid may be a working fluid such as that described with respect to FIG. 5 herein. Additionally, the temperature sensor 612 may be located in proximity to the bubble generator 602. The temperature sensor 612 may be located outside of the cavity 604 to measure ambient temperature of the surrounding environment. In some implementations, there may be multiple temperature sensors 612 where each temperature sensor 612 is located outside, within, adjacent to, or in physical contact with the cavity 604.

The bubble generator 602 may include any type of device capable of forming a gas bubble within the cavity 604. The bubble generator 602 may include, without limitation, a thermal energy source, a sonic energy source, an electrical energy source, or a chemical energy source for generating a bubble. In some implementations, the bubble generator 602 includes a resistive element in electrical communication with the controller 610. In response to electrical pulses or current from the controller 610, the resistive element can emit thermal energy, effectively heating a portion of the fluid surrounding the resistive element. The resistive element may increase the temperature of its surrounding fluid such that the surrounding fluid experiences a phase change from the liquid phase to gas phase. Hence, the resistive element is able to operate as a bubble generator 602.

The bubble generator 602 may include a passive bubble generator or an active bubble generator. A passive bubble generator may include a passive nucleation site that encourages bubble formation. The passive nucleation site may include a particular material (such as an epoxy) or an engineered surface to promote bubble formation (such as a surface defect, discontinuity, or surface inconsistency). An active bubble generator may include a heating element such as a resistor or resistive element as discussed above, although active bubble generation may be implemented in other ways. For example, the bubble generator 602 may utilize electrolysis to form a gas bubble. Alternatively, the bubble generator 602 may generate sonic or acoustic pressure waves to create a bubble. And in some implementations, the bubble generator 602 may include a combination of active and passive bubble generation elements.

In some implementations, the controller 610 controls the operation of the bubble generator 602 in response to a signal from the temperature sensor 612. When a set temperature is measured by the sensor 612, for example one or more degrees Celsius (C) above a critical temperature when bubbles are expected to form within the liquid-filled cavity 604, the controller 610 may be configured to activate the bubble generator 602 by providing electrical current or pulses to the bubble generator 602.

In operation, the cavity 604 is at least partially filled with a working fluid. In some implementations, the cavity 604 is filled while the working fluid is at a temperature below typical ambient temperature, however, in some other implementations, the temperature may be higher. Ambient temperature may include the temperature of the surrounding environment under all seasons and geographic locations. The ambient temperature of operation for displays described herein can include a range from about −20 degrees C. to about 60 degrees C. and such displays are expected to perform over that range. The ambient temperature for storage of the displays described herein includes a temperature range from about −30 degrees C. to about 80 degrees C. Typical ambient temperature may include temperatures in the range of about 15-30 degrees C. As the temperature of the display assembly 600 decreases, the working fluid and components of the display assembly 600 contract. However, the working fluid may contract at a faster rate than the display assembly 600 components, resulting in reduced pressure and the formation of voids or bubbles within the cavity 604. To prevent the formation of bubbles in the viewable portion 606, the controller 610 and bubble generator 602 can be implemented to direct the formation of a bubble in the non-viewable portion 608 instead. The controller 610 can monitor the temperature signal from the temperature sensor 612. When the temperature drops to a set temperature threshold, for example, about 6 degrees C., the controller 610 can send an electronic signal to activate the bubble generator 602. The bubble generator 602, in turn, generates a bubble, or bubbles, within the non-viewable portion 608, which inhibits the formation of bubbles anywhere else within the cavity 604.

When the pressure inside the cavity 604 reaches the vapor pressure of the fluid at about the temperature threshold, one or more bubbles can be generated by the bubble generator 602. However, once the bubble forms, the pressure in the cavity 604 will remain constant at a given temperature as long as a bubble is present because the bubble can expand or contract to compensate for volume changes of the remaining fluid. Therefore, once a bubble is formed by the bubble generator 602 in the non-viewable portion 608, the pressure will remain sufficiently stable at a given temperature to prevent bubble formation in another location of the cavity 604. In some implementations, the critical temperature of the fluid in display assembly 600 may be about 5 degrees C. Hence, the temperature threshold for controller 610 may be set at, for example, about 6 degrees C. to ensure that bubble formation occurs at the bubble generator 602 instead of anywhere else within the cavity 604.

FIG. 6B is a diagram of a display assembly 650 including a resistive element 652. The display assembly 650 includes a liquid-filled cavity 656 having a viewable portion 658 and a non-viewable portion 660. The display assembly 650 includes a controller 662 in electrical communication with the resistive element 652 and a sensor 654. The sensor 654 may be a temperature sensor, pressure sensor, or include both a pressure and temperature sensor. In some implementations, the display assembly 650 may include multiple sensors 654. For example, the display assembly 650 may include one or more temperature sensors 654 and one or more pressure sensors 654. Each sensor 654, whether a temperature or pressure sensor, may be located outside, within, adjacent to, or in physical contact with the cavity 656.

In operation, the cavity 656 is at least partially filled with a working fluid. In some implementations, the cavity 656 is filled while the working fluid is at a temperature below typical ambient temperature. However, in other instances, the temperature may be higher. As the temperature of the display assembly 650 decreases, the working fluid contracts. To prevent the formation of bubbles in a viewable portion 658, the controller 662 directs the formation of a bubble in the non-viewable portion 660 instead. The controller 662 monitors a signal from the sensor 654. When the controller 662 determines that the sensor 654 signal exceeds or diminishes below a threshold, which in some implementations may be predefined, the controller 662 sends an electronic signal to resistive element 652 within the non-viewable portion 660. The controller 662 may be configured to initiate bubble formation at the resistive element 652 at about 6 degrees C. The heat from the bubble generator then increases the temperature of the liquid proximate to the resistive element 652 to above 6 degrees C. such that some working fluid changes phase to a gas, resulting in the formation of a bubble proximate to the resistive element 652 which is located in the non-viewable portion 660.

More generally, because the bubble formation temperature is dependent upon the temperature at which a display assembly is sealed, the controller 662 may be configured with a temperature setting or threshold, which in some implementations may be predetermined, to activate a bubble generator based on the temperature at which a display assembly is sealed. In some implementations, the display can cool down 15 to 20 degrees C. below the seal temperature before a vapor bubble may form. For example, if the display assembly is sealed at 22 degrees C., the vapor bubble may form at 22-15 degrees C., which is 7 degrees C. In another example, if the display is sealed at 0 degrees C., then the temperature at which a bubble may form will be about −15 degrees C. A person having ordinary skill in the art will readily understand that the display may cool down even more than described in these examples before the bubble may form, depending on the design constraints and the sealing temperatures. In some implementations, the bubble may form when the fluid is very near to its vapor pressure, i.e., where small temperature changes can affect phase. Thus, in some implementations, the temperature threshold setting is determined by measuring the temperature of the display assembly or fluid at the time of sealing the display assembly. Alternatively, the controller 662 may be configured or programmed with a temperature threshold and the temperature at the time of sealing is controlled to be about 5-80 degrees above the temperature threshold, such as 10-20 degrees, or 15-40 degrees.

The controller 662 also may receive pressure signal information from a pressure sensor 654. The controller 662 may regulate the activation of the resistive element 652 in response to the measured pressure with the cavity 656. For instance, the controller 662 may send current to the resistive element 652 to cause the formation of a bubble, but then monitor pressure within the cavity 656 and regulate the amount of current to the resistive element 652 to control the pressure within the cavity 656. When the pressure within the cavity 656 exceeds a high pressure limit, the controller 662 may discontinue sending current or pulses to the resistive element 652. The pressure inside the display will decrease when the glass is prevented from contracting any further with the fluid in the cavity 604 or 656. This may be due to bumps or spacers on the substrates defining the cavity 604 or 656 preventing the glass to follow the fluid contraction. At this point, the pressure inside the cavity 604 or 656 will fall as the display cools down. When the pressure inside the cavity 604 or 656 reaches the vapor pressure of the fluid, a bubble will form at that pressure and temperature. The pressure within the cavity 604 or 656 will remain constant as long as a bubble is present. If the temperature continues to decrease, the controller 610 or 662 may no longer activate or send pulsing signals to the bubble generator 602 or 654 because the bubble will remain formed. If the temperature increases and the bubble is present, the pressure in the cavity 604 or 656 will remain constant. The pressure will only increase when the bubble disappears. Hence, the controller 662 may deactivate or discontinue sending current or pulses to the resistive element 652 when a set pressure threshold is reached. The controller 662 may activate or deactivate a bubble generator such as the resistive element 652 when a pressure change is detected. In some implementations, the controller 662 uses the sensor 654 for both temperature and pressure sensing to control the bubble generator 652.

FIGS. 7A-7C are views of display assemblies 700 including bubble generators 708, 710 and 714 and bubble trapping regions 704, 706 and 718, respectively, on a substrate. To eliminate the formation of bubbles within a certain part of the display such as the viewable portion 606 and 658 as depicted in FIGS. 6A and 6B, respectively, a bubble generator 708, 710 or 714 induces a bubble, or bubbles, to be formed within different parts of the display. The different parts of the display may include areas that are under cover. The bubble generator 708, 710 or 714 may induce a bubble or bubbles within a portion of the working fluid volume contained in the cavity enclosed by the sealing material and the substrates such as in FIG. 5 or in the cavities 604 and 656 of FIGS. 6A and 6B. The cavities 604 and 656 within the display assembly 600 or 650, as depicted in FIGS. 6A and 6B, respectively, may be defined by two substrate surfaces facing each other across a gap and the sealing material joining them. If a bubble is maintained throughout the life of a display assembly 600 within a non-viewable portion 608 or space, it will prevent other bubbles from forming. If however, conditions lead to the dissolution of all bubbles (for example, because of high pressure, high temperature, or other conditions), the bubble may reform within any location of the working fluid when conditions are optimal for its formation. FIGS. 7A-7C illustrate the positioning of one or more bubble generators 708, 710 and 714 and bubble trapping regions 704, 706, 718 within either or both of the substrates defining parts of the cavity enclosed by a seal (and preferably in a location that does not interfere with the device operation), and the inducement of a bubble within a non-viewable portion of the cavities.

Because of capillary action from the height of the bubble trapping region, primarily determined by the height of the adhesive seal 528 depicted in FIG. 5, and the selection of a working fluid that is energetically favorable (one example is oil, although any working fluid with similar characteristics may be suitable), once the bubble comes to reside in a bubble trapping region 704, 706 and 718, it will remain there, primarily displacing itself within it. The bubble 702, 712 and 716 will not escape, as long as its volume does not exceed the available volume within the bubble trapping region 704, 706 and 718. In this fashion, by creating and maintaining the bubble using a bubble generator 708, 710 and 714 within or in proximity to the bubble trapping region, and engineering the bubble to bubble trapping region ratio, the display assembly 700 can control the location of any display bubbles 702, 712 and 716.

The size and depth of the bubble trapping region 704, 706 and 718 may be influenced by a number of factors. These include, without limitation: the properties of the working fluid, the volume of the working fluid being used in the display (itself roughly a measure of display size and heights between substrates), the expected lowest and highest temperatures to which the display will be exposed, and the expansion coefficients of both the working fluid and the substrates and/or other materials forming the working fluid volume. Considering those and other factors, a bubble trapping region 704, 706 and 718 is created that is big enough to hold the largest possible bubble expected to be formed (typically at the lowest temperature), without allowing it to spill out of the bubble trapping region under all conditions. In general, a bubble trapping region 704, 706 and 718 that is two to three times as wide as it is deep may be optimal, although other combinations are effective. In some implementations, the bubble trapping region depths may be about 10 microns to about 500 microns (a function of the substrate thickness without compromising substrate mechanical integrity), with respective widths as described above. In some implementations, a bubble trapping region 704, 706 and 718 is in the form or shape of a trench. A trench may be optimal for display assemblies or devices, where the edges of the display assembly are outside of the active region used for mechanical attachments and either not viewable (such as the non-viewable portion 608 depicted in FIG. 6A) by the user, or of lesser optical value. Bubble generators 602 and bubble trapping regions 704, 706 and 718 in such areas of these devices may be created while minimizing or eliminating any detrimental effect that a bubble may have in either the operation or the perceived quality of the display assembly. In some implementations, the location and shape of the bubble trapping region 704, 706 and 718 may be in any number of other geometric shapes, such as circles, squares, rectangles.

In some implementations, each bubble trapping region 704, 706 and 718 may be created via a variety of methods. These may include acid etching, laser etching, spark-cutting, plasma etching, mechanical drilling or sawing, sandblasting and any other method that can remove material in a desired shape. The method used may determine the shape of the bubble trapping region 704, 706 and 718. For example, mechanical milling means (such as, saws, plasma etching) may be used to create sharp edged bubble trapping regions. Alternatively, many ablation methods (such as forms of laser etching, sandblasting, as well as some chemical methods) may create dug-out, trench or scooped bubble trapping regions 704, 706 and 718.

The bubble trapping regions 704, 706 and 718 within either substrate, such as the substrates 504 and 522 of FIG. 5, may be created at any number of steps during the manufacturing process. Those skilled in the semiconductor and glass fabrication arts will appreciate that if the process is done before thin film processing, a backfill material will help with the sensitivity of the processing towards topography. Alternatively, any bubble trapping region 704, 706 and 718 created on either substrate after all MEMS creation steps have been performed should protect the delicate mechanical parts from any debris formed. In some implementations, this can be achieved by the addition of a protective layer which is subsequently removed after the bubble trapping region creation. In some other implementations, additional steps such as coating the walls of the bubble trapping region 704, 706 and 718 with a light absorbing film may be undertaken.

FIGS. 7A-7C show various layouts that may be used to implement the bubble trapping regions 704, 706 and 718. In FIG. 7A, the bubble trapping region 704 is implemented along the side of the display assembly 700. FIG. 7A also shows the bubble generator 708 within or adjacent to the bubble trapping region 704. The bubble 702 occupies a portion of the available bubble trapping region 704 volume. As seen in FIG. 7B, multiple discrete bubble trapping regions 704 and 706 may be implemented along with corresponding bubble generators 708 and 710. Each bubble trapping region 704 and 706 may include a bubble 702 and 712. FIG. 7C illustrates a configuration where three discrete bubble trapping regions 704, 706 and 718 within the same display assembly 700, where each contains a bubble generator 708, 710 and 714 along with bubbles 702, 712 and 716.

FIG. 8 is another view of a display assembly 800 including a bubble generator 806 and continuous bubble trapping region 804 along the periphery of the display assembly 800. In the illustrative implementation, the bubble trapping region 804 occupies the majority of the sides of the display assembly 800. In some other implementations, the bubble trapping region 804 can extend along all sides of the display assembly 800.

FIG. 9 is a cross-sectional view of a display assembly 900 having a bubble trapping region 948. The display assembly 900 is an example of a display utilizing a MEMS-down modulator substrate 908, coupled across a gap to an aperture plate 902 by the sealing material 922 around the periphery. The sealing material 922 and the aforementioned first and second substrates, creates a space or cavity 920 enclosed by the seal, which is then substantially filled with a fluid. The bubble trapping region 948 has been created in the shape of a trench extending along the majority of at least one edge of the aperture substrate 902. In some implementations, the bubble trapping region 948 is located outside the viewable potion of the display assembly 900, such as within the non-viewable portion. The display assembly 900 may include a bubble generator within or in proximity to the bubble trapping region 948.

The display assembly 900 may additionally incorporate a controller 910, and an electrical connection 924 between the substrates 902 and 908. The controller 910 may be in electrical communication with a sensor, or with a bubble generator, or with both. In some implementations, the bubble trapping region 948 is created within the surface of the second substrate 902, while the first substrate 908 has no bubble trapping region. In some other implementations, the bubble trapping region 948 is included on the first substrate 908 surface. In some implementations, one or more bubble trapping regions can be included on both substrates 902 and 908.

Although the display assembly 900 is illustrative of a bubble trapping region 948 where the light modulators are in a MEMS-down configuration, in some implementations, the bubble trapping region 948 can be formed where the light modulators are in a MEMS-up configuration. For that configuration, for instance, the bubble trapping region 948 can be formed into either the modulator substrate, such as the substrate 504 or the cover plate, such as the cover plate 522, depicted in FIG. 5.

The various aspects are also applicable for incorporation with liquid crystal displays. Although liquid crystal displays often incorporate liquids of high viscosity (>100 centipoise) and relatively low vapor pressures, it is known that bubbles can nevertheless be introduced within the liquid crystal as part of the fluid-fill or manufacturing process. These bubbles are then subject to unwanted and uncontrolled increases or decreases in volume as a function of ambient temperature and/or pressure on the display. The incorporation of a bubble trapping region with an LCD display assembly cavity may be employed to contain the location of the bubble, especially if that bubble trapping region extends along the majority of one edge of the display. Those skilled in the art will quickly grasp that in some implementations, the bubble trapping region can be located on the modulator substrate, while in some other implementations, it can be located on the color filter substrate. Moreover, these implementations are also applicable to electrowetting displays in which a bubble generator and bubble trapping region can be arranged with or formed onto either the modulator substrate, which provides drive signals for the motion of the fluids, or onto the cover plate.

Once the bubble trapping regions are created and the bubble generator is arranged proximately to the bubble trapping region, the substrates can be carefully aligned and bonded together to create a cavity.

FIGS. 10A and 10B are views of a display assembly 1000 including bubble trapping regions 1016 formed by the geometric matching of substrates 1002, 1004 and 1006. In some implementations, the bubble trapping region or bubble hosting function may be accomplished by the geometric placement of substrates atop each other, similar to the space or recess created by a shelf overhang. FIG. 10A shows a configuration where this is accomplished by placing a MEMS-down modulator substrate 1004 across a gap maintained by spacers 1010 on top of an aperture substrate 1002. FIG. 10A shows that the center substrate 1004 may be the modulator substrate, while in another display assembly, it may be the aperture, and in further display assembly, a thin film. In some implementations, the center substrate 1004 is an aperture substrate attached to a third substrate 1006, which is sized to match the modulator substrate 1002. In some other implementations, the center substrate 1004 could be the modulator substrate attached to the third substrate 1006 opposite the aperture substrate 1002. In some implementations, the third substrate 1006 remains as the aperture substrate, while the center substrate 1004 is a thin film or tape.

A seal 1008 may be used around the periphery, which creates the cavity 1014 enclosed by the sealing material 1008. The cavity 1014 can be substantially filled by the fluid, except for the portion of the volume within one or more of the bubble trapping region 1016 which is occupied by the bubble 1012 which may be induced as described with respect to FIGS. 6A and 6B. In some implementations, the spacers 1010 maintain the gap between substrates, effectively including the active optical area or viewable portion of the display assembly 1000. This gap may be as small as 1 micron, or as large as 15-20 microns, such as about 10 microns. The height of this bubble trapping region 1016 results from the height of the seal material 1008 and the thickness of the center substrate 1004.

In some implementations, the bubble trapping region 1016 occupies at least twice the height of the gap created by the spacers 1010 to prevent the migration of the bubble into the gap between the substrates that is intended for user viewing (such as the viewable portion 606, as depicted in FIG. 6A). In some other implementations, the bubble trapping region 1016 is created as a central shelf, fully surrounding the center substrate 1004. In some implementations, a similar effect is accomplished by creating a three sided shelf, a two sided shelf or a shelf on one side.

A similar shelf effect may be accomplished in the implementation shown in FIG. 10B, where the substrate 1005 is created with higher thickness, and one or more spaces around the edge are worn or milled (again using mechanical or chemical means similar to those used in creating the bubble trapping region) to ensure the bubble 1012 remains located in this space.

In some implementations, the display assembly 1000 includes electrical connections to the substrate surfaces within the space enclosed by the seal 1008. As shown in FIG. 9, in some implementations, this is accomplished by an electrical connection 924 between the substrates. As shown in the example of FIG. 10A or 10B, this also may be accomplished inside this space or cavity 1014. In some implementations, this may be accomplished by placing pads with the appropriate signal on one of the substrates, a similar pad with a via on the substrate across the gap, then placing a conductive or silver epoxy spacer 1011 (or a similar hardening conducive material) in place of the non-conducive spacer 1010 structure. In this fashion, both sides of the display assembly 1000 would be connected via connections across the gap between substrates. As with the case of the bubble trapping region in FIG. 10B, the conductive pads and spacers 1011 can be used to electrically connect the upper and lower substrates. Also, as is the geometric case of FIG. 10A, the shelf may be built all around, on three sides, on two sides or on one side.

FIGS. 11A and 11B are top and cross-sectional views of a display assembly 1100 utilizing a spacer wall of closely spaced apart spacers 1110 to create a bubble trapping region. The display assembly 1100 also includes a bubble generator 1118 such as those described with respect to FIGS. 6A and 6B. The bubble generator 1118 may be controlled by a controller such as controller 610 and 662 as described with respect to FIGS. 6A and 6B. This configuration has the advantage of using a single gap distance within the complete display assembly 1100, unlike other configurations where a larger or higher bubble trapping region or space is created to house the bubble. A substrate 1104 is placed on another substrate 1102. As in the case of FIG. 9, the substrate 1104 may either be the aperture or modulator substrate, as long as the other substrate 1102 is its complement. The sealing material 1108 is used to create the cavity or space enclosed by the seal 1116 that will be filled with the working fluid. The spacers 1110 are used to maintain the correct gap distance between substrates. In the illustrated configuration, the spacers 1110 are closely located to create a wall structure with a gap between the display area and the sealing material 1108.

The cavity enclosed by the seal is sealed to the outside world through the use of one or more plugs 1109, while the bubble 1112 is formed as described with respect to FIGS. 6A and 6B. This peripheral corridor serves as a partition in the cavity enclosed by the seal to restrict any generated bubbles from entering the internal viewable portion 606 or 1114 of the display assembly 600 or 1100. Because, in this configuration, the bubble trapping region height is equal to the height of the cavity enclosed by the seal, special care is taken to prevent the migration of the bubble into the viewable portion of the display across the spacer wall 1110. This is accomplished by minimizing the size of the spacer wall openings 1106 across the spacer wall 1110 to about 1 or 2 microns. This allows fluid flow while keeping the bubble 1112 within the bubble trapping region. However, a person having ordinary skill in the art will readily understand that the size of the spacer wall openings 1106 can be adjusted, depending on the design constraints of the display device.

In some implementations, the bubble trapping region is created by treating portions of the substrate within the cavity enclosed by the seal with a high surface tension coating which oil does not wet. As before, this may be done along the edge, or in any area considered appropriate. Because the oil does not readily wet the area treated with the coating, any bubbles that are generated by the bubble generator 1118 will form and remain on the area treated with the coating.

FIG. 12 is a flow diagram of a process 1200 for controlling the formation of bubbles in a display assembly such as the display assemblies 600, 700, 800, 900, 1000 and 1100 described above. The process 1200 for controlling bubble formation within a display includes providing a cavity having a plurality of light modulators where the cavity includes a viewable portion and a non-viewable portion (block 1202). The cavity can be filled with a liquid (block 1204). And a bubble can be generated using a bubble generator which may be positioned within the non-viewable portion of the display assembly (block 1206).

The process 1200 also may include measuring a temperature of the display assembly. In some implementations, the process 1200 includes controlling the operation of the bubble generator in response to measuring the temperature of the display assembly. Measuring may be performed by a temperature sensor located within the cavity. The process of controlling the operation of the bubble generator may be performed in response to a signal from a pressure sensor in physical communication with the cavity. The bubble generator may include a heat source. The heat source may include a resistor arranged to generate heat in response to a signal from the controller.

FIG. 13 is a flow diagram of a process 1300 for manufacturing a display assembly, including a bubble generator, such as the display assemblies 600, 700, 800, 900, 1000, and 1100 described above. The process 1300 of manufacturing a display assembly includes providing first and second substrates (block 1302). Providing a bubble generator on at least one of the first and second substrates (block 1304). The first and second substrates can be joined together, for example by using a sealing material. The sealing material can be arranged partially around the periphery of the first and second substrates to form a cavity. The first and second substrates can be joined such that the bubble generator is located within a non-viewable portion of the cavity. (block 1306). The cavity can be filled, substantially, with a fluid (block 1308). And the cavity can be sealed (block 1310). The process 1300 also may include forming at least one bubble trapping region on a surface of at least one of the first and second substrates.

FIGS. 14A and 14B are system block diagrams illustrating a display device 40 that includes a plurality of light modulator display elements. The light modulator display elements may include one or more display assemblies such as described with respect to FIGS. 6A-13 herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include a light modulator-based display, as described herein.

The components of the display device 40 are schematically illustrated in FIG. 14A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as a light modulator display element controller). Additionally, the array driver 22 can be a conventional driver or a bi-stable display driver (such as a light modulator display element driver). Moreover, the display array 30 can be a conventional display array or a bi-stable display array (such as a display including an array of light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware components, software components, or combination thereof, and in various configurations.

As used herein, a phrase referring to “at least one of a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus comprising:
a cavity including a plurality of light modulators, the cavity being filled with a liquid, the cavity including a viewable portion and a non-viewable portion; and
a bubble generator being positioned within the non-viewable portion of the cavity and arranged to form a bubble within the non-viewable portion.

2. The display apparatus of claim 1, further comprising a controller arranged to control the operation of the bubble generator.

3. The display apparatus of claim 2, further comprising a temperature sensor arranged to measure the temperature of the display apparatus.

4. The display apparatus of claim 3, wherein the controller controls the operation of the bubble generator in response to a signal from the temperature sensor.

5. The display apparatus of claim 3, wherein the temperature sensor is located within the cavity.

6. The display apparatus of claim 2, further comprising:
a pressure sensor in physical communication with the cavity and electrical communication with the controller, wherein the controller controls the operation of the bubble generator in response to a signal from the pressure sensor.

7. The display apparatus of claim 1, wherein the bubble generator includes a heat source.

8. The display apparatus of claim 7, wherein the heat source includes a resistor arranged to generate heat in response to a signal from the controller.

9. The display apparatus of claim 1, wherein the non-viewable portion includes a region in which a bubble is allowed to form or move.

10. The display apparatus of claim 1, wherein the display is arranged to communicate with a processor, the processor being configured to process image data and communicate with a memory device and receive input data from an input device.

11. The display apparatus of claim 10, wherein the display apparatus receives at least one signal from a driver circuit configured to receive at least a portion of the image data from a controller.

12. The display apparatus of claim 11, wherein the processor is configured to receive the image data from an image source module, the image source module including at least one of a receiver, transceiver, and transmitter.

13. A method for controlling bubble formation within a display, comprising:
providing a cavity including a plurality of light modulators, the cavity including a viewable portion and a non-viewable portion;
filling the cavity with a liquid; and
generating a bubble using a bubble generator positioned within the non-viewable portion of the cavity.

14. The method of claim 13, further comprising measuring a temperature of the display.

15. The method of claim 14, further comprising controlling the operation of the bubble generator in response to measuring the temperature of the display.

16. A system for controlling bubble formation within a display comprising:
a cavity including a plurality of light modulators, the cavity being filled with a liquid, the cavity including a viewable portion and a non-viewable portion; and
a means for generating a bubble within the non-viewable portion of the cavity.

17. The system of claim 16, further comprising a means to control the operation of the bubble generator.

18. The system of claim 17, further comprising a means to measure the temperature of the display, wherein the means to control the operation of the bubble generator receives a signal from the means to measure the temperature.

19. A method of manufacturing a display assembly, comprising:
providing first and second substrates;
providing a bubble generator on at least one of the first and second substrates;
joining the first and second substrates via a sealing material arranged partially around the periphery of the first and second substrates to form a cavity such that the bubble generator is located within a non-viewable portion of the cavity;
substantially filling the cavity with a fluid; and
sealing the cavity.

20. The method of claim 19, further comprising forming at least one bubble trapping region on a surface of at least one of the first and second substrates.
